(19) United States
(12) Patent Application Publication
(10) Pub. No.: US 2024/0161973 A1
(43) Pub. Date: May 16, 2024

(54) Inductive power supply system and coil thereof

(71) Applicant: Fu Da Tong Technology Co., Ltd., New Taipei City (TW)

(72) Inventors: Ming-Chiu Tsai, New Taipei City (TW); Chi-Che Chan, New Taipei City (TW)

(73) Assignee: Fu Da Tong Technology Co., Ltd., New Taipei City (TW)

(21) Appl. No.: 18/419,459

(22) Filed: Jan. 22, 2024

(30) Foreign Application Priority Data
Aug. 10, 2023 (TW) 112130052

(51) Int. Cl. H01F 38/14; H01F 27/28; H02J 50/10

(52) U.S. Cl. CPC H01F 38/14; H01F 27/2823; H02J 50/10

(57) ABSTRACT

Abstract of Disclosure

A coil for an inductive power supply system includes a metal conducting wire and a nonmetal spacing wire. The metal conducting wire and the nonmetal spacing wire are wound together to form the coil. An inductive power supply system includes a first coil for a power supply end and a second coil for a power receiving end. Each of the first coil and the second coil is formed by winding a metal conducting wire and a nonmetal spacing wire together.

### BACKGROUND OF THE INVENTION

### 1. Field of the Invention

The present invention relates to an inductive power supply system and a related coil, and more particularly, to an inductive power supply system and a related coil having favorable electromagnetic sensing performance.

### 2. Description of the Prior Art

In an induction type power supply system, each of the power supply end and the power receiving end includes a coil. Through inductive sensing the electric power or control signals may be delivered by the coils within a certain sensing distance. The sensing distance refers to the relative distance of the two coils. In general, if the distance of the coils is closer, the power delivery efficiency will be higher; otherwise, if the distance of the coils is farther, the power delivery efficiency will be lower. The longest effective distance of the coils is the maximum relative distance between the coils under the worst acceptable efficiency in the application, and the shortest effective distance of the coils is the minimum distance that the two coils can transmit power under normal operational conditions of the inductive power supply system. The effective sensing distance is directly associated with the coil size. A larger coil size can usually achieve a better performance. However, the space in the actual product that can contain the coil is limited, and the increase in coil size may increase the costs.

Thus, there is a need to provide a novel coil design, which may realize a coil with high performance and low costs under a limited space.

### SUMMARY OF THE INVENTION

It is therefore an objective of the present invention to provide a coil structure, where a nonmetal spacing wire is commonly wound to achieve high performance and low costs simultaneously.

An embodiment of the present invention discloses a coil for an inductive power supply system. The coil comprises a metal conducting wire and a nonmetal spacing wire. The metal conducting wire and the nonmetal spacing wire are wound together to form the coil.

Another embodiment of the present invention discloses an inductive power supply system, which comprises a first coil and a second coil. The first coil, which is used for a power supply end of the inductive power supply system, is formed by winding a first metal conducting wire and a first nonmetal spacing wire together. The second coil, which is used for a power receiving end of the inductive power supply system, is formed by winding a second metal conducting wire and a second nonmetal spacing wire together.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a coil according to an embodiment of the present invention.

FIG. 2 is a schematic diagram of a coil according to an embodiment of the present invention.

FIG. 3 is a schematic diagram of a coil according to an embodiment of the present invention.

FIG. 4 is a schematic diagram of a coil according to an embodiment of the present invention.

FIG. 5 is a schematic diagram of a coil according to an embodiment of the present invention.

FIG. 6 is a schematic diagram of an inductive power supply system according to an embodiment of the present invention.

### DETAILED DESCRIPTION

The automatic manufacturing method of coils is to place a conducting wire into an automatic winding machine to be wound and then form and fix it. The forming and fixing methods include hot melt forming or chemical forming, etc. Since the hot melt forming method can form quickly, it has become the mainstream in the industry. In order to realize the hot melt forming, hot melt adhesive may be applied to the outer layer of the coil to bond the coil through heating after winding is completed. The coil may further be bonded to a magnetic material (such as a magnetic conductor), and a nonmetal shell may be added to form a coil module. The magnetic material may be used for enhancing the resonance performance of the coil and guiding the delivery direction of coil energies. The nonmetal shell may be used for protecting the coil structure, to prevent the coil from being damaged by external forces.

In detail, the coil mold of the automatic winding machine is equipped with a spindle. After the wire is introduced to the surface of the spindle and fixed on the spindle, the spindle starts to rotate to wind and stack. The more turns it winds, the larger the coil size will be. After the winding reaches a preset number of turns, the spindle stops rotating, and then the machine cuts the wire and forms and fixes the coil. After the wire of the coil is bonded, the machine will separate the coil from the mold. At this time, the coil is completed wound. A standard coil has a circular structure, and there is a hollow formed by the spindle of the mold inside the coil. The size of the hollow represents the inner diameter of the coil, and the outer boundary of the outermost wire of the coil refers to the outer diameter of the coil. Both ends of the wire of the coil may be respectively connected to a circuit. Parts of the wires extending from the innermost round and the outermost round of the coil toward the circuit are called the leads. During the sensing operation of the coil, the lead wire has no sensing capability.

In the inductive power supply system, a coil may be deployed on the power supply end, and another coil maybe deployed on the power receiving end. During the power transmission operation, energies of the supplying-end coil may be sent to the receiving-end coil. When the loads on the power receiving end increase and drain more power, the current flowing through the wires of the coils may also increase. After the power increases, there may also be a larger current passing through the wires of the coils. Under the same current condition, larger wire impedance may generate increasing losses and heating, and a longer wire may have larger impedance such that the efficiency will become worse. In general, the coil may be manufactured by using a thicker wire to reduce the impedance.

Therefore, the coil design is usually requested to meet the following requirements: first, the coil size is as large as better. However, the practical product has a limited space that cannot accommodate an excessively large coil, and furthermore, enlarging the coil will inevitably increase the material cost. Second, the sensing area of the coil is as large as better. In practical applications, the coil sensing relies on the area composed of conducting wires to perform sensing and deliver energies. A larger sensing area may be constructed if the inner diameter of the coil is smaller and the outer diameter of the coil is larger. However, such a design is often accompanied by an increase in wire length, resulting in increased impedance and reduced efficiency. Third, the coil impedance is as low as better. The general coil design method is to reduce the impedance by thickening the wire width or shortening the wire length. However, if the sensing distance needs to be increased, the outer diameter should be increased but the length and impedance of the wire are requested to be well controlled, the inner diameter has to be enlarged to reduce the number of winding turns, resulting in a reduced sensing area and poor transmission efficiency. Moreover, the wire itself has costs and weights. When the wire is thickened, the costs and weights will increase, which has limitations in practical manufacturing.

As can be seen from above, the conventional coil design method usually fails to satisfy the above three requirements. If any of the requirements needs to be satisfied, the performance in other aspects may be reduced, and a tradeoff is necessary. The applicant proposed a method of previously cutting a slot on a nonmetal upper lid in U.S. Pat. No. 10,784,042 B2, where the wire is inserted into the slot to form the coil. This approach may form spacing between the wires of the coil, so that the number of turns and the length of the coil may be reduced. This approach may also meet the advantages of increasing the coil sensing area and decreasing the coil impedance. High efficiency coils may be produced by using this method, but the manufacturing process is cumbersome and costly, making it unfavorable for mass production.

In order to improve the above shortcomings of difficulty in production, the present invention provides a coil structure that is wound by using metal conducting wires along with nonmetal spacing wires, to meet the needs of enlarging the coil size and increasing the coil sensing area and also keep low impedance. In addition, the coil of the present invention may be wound and produced in an automatic manner, and its production is fast and low-cost.

In an embodiment, a metal conducting wire and a nonmetal spacing wire are wound together to form a coil. FIG. 1 is a schematic diagram of a coil 10 according to an embodiment of the present invention. The coil 10 includes a metal conducting wire 102 and a nonmetal spacing wire 104, and is produced by winding the metal conducting wire 102 and the nonmetal spacing wire 104 in parallel. In order to realize a larger coil sensing area and keep lower coil impedance (i.e., a shorter coil length), if the metal conducting wire 102 and the nonmetal spacing wire 104 are wound on a plane, the metal conducting wire 102 and the nonmetal spacing wire 104 may be bonded along the direction of the plane, so that different segments of the metal conducting wire 102 are separated by the nonmetal spacing wire 104. For example, as shown in FIG. 1, the outermost first and second rounds of the metal conducting wire 102 are separated by the first round of the nonmetal spacing wire 104 to have a gap. Therefore, the structure of the wound coil 10 is a round of metal, a round of nonmetal, a round of metal, a round of nonmetal, etc. arranged alternately in sequence.

Traditionally, the entire coil is made by winding a metal conducting wire. In order to achieve a sufficient sensing area, more turns need to be wound, which increases the overall wire length, thereby causing an increase in impedance and a decrease in efficiency. In contrast, the coil of the present invention is made of a metal conducting wire and a nonmetal spacing wire wound in parallel; hence, in the finished product of the coil, every two rounds of the metal conducting wire are separated by the nonmetal spacing wire. Compared with the conventional coil with an all-metal winding structure, due to the gap between the conducting wires of the coil of the present invention, the required number of turns of the conducting wires is decreased by half under the same coil size, and the same sensing area may still be achieved. At the same time, the length of the wire is decreased by half to keep lower impedance.

In addition, the coil structure of the present invention may be produced by using the double-wire parallel winding technology on an automatic winding machine, and has the advantage of being suitable for automatic production. The costs may be significantly reduced in mass production. For example, in the embodiment of FIG. 1, adhesive may be plated on the surface of the metal conducting wire 102 and the nonmetal spacing wire 104, respectively. When the coil is formed, the adhesive on the conducting wire and the spacing wire becomes sticky through temperature changes or chemical effects. Therefore, the metal conducting wire 102 and the nonmetal spacing wire 104 may be bonded and fixed to each other, and the coil product may be easily completed by using an automatic winding machine to perform automatic winding.

The nonmetal spacing wire 104 may be made of any material that does not have electric conducting and electromagnetic sensing capabilities. In an embodiment, the nonmetal spacing wire 104 may be realized by using a plastic wire similar in shape and hardness to the metal conducting wire 102, so that the two wires may be wound in parallel easily. The plastic wire is not capable of conducting electricity and electromagnetic sensing, and can pass the electromagnetic energies without consuming energies or interfering with the sensing function of the metal coil. In addition, the plastic wire has the advantages of light weight and cheap materials, which may reduce the weight when manufacturing a large-size coil and also reduce the costs in mass production. Furthermore, if an elastic plastic wire is used, the gap between different rounds of metal conducting wire may further be flexibly adjusted to realize different applications.

Note that in the coil 10, only the metal conducting wire 102 has the electromagnetic sensing capability. Therefore, in order to achieve a larger outer diameter (equivalent to a larger sensing area), the metal conducting wire 102 should preferably be disposed outside the nonmetal spacing wire 104. In other words, the outermost round of the coil 10 is the metal conducting wire 102.

In several embodiments, a plastic wire having elastic material may be used as the nonmetal spacing wire, and different rotational torques may be applied when the coil is wound and manufactured, causing the plastic wire to deform under stress to change its width. In such a situation, different segments of the nonmetal spacing wire may have different widths. In general, increasing the torque will decrease the width of the plastic wire to reduce the gap between metal conducting wires; and decreasing the torque will increase the width of the plastic wire to enlarge the gap between metal conducting wires.

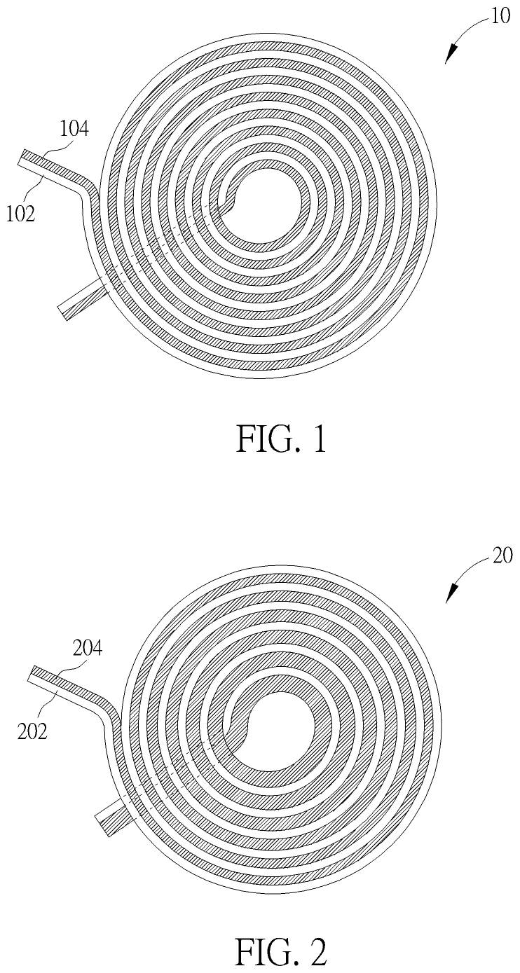

For example, FIG. 2 is a schematic diagram of a coil 20 according to an embodiment of the present invention. The coil 20 is formed by winding a metal conducting wire 202 and a nonmetal spacing wire 204 together, where the nonmetal spacing wire 204 has an elastic material, and may form a coil with different widths by winding with different torques. In this embodiment, the segment on the inner rounds of the nonmetal spacing wire 204 has a larger width. During the winding process, the torque is gradually increased from inside out, so the segment on the outer rounds of the nonmetal spacing wire 204 has a smaller width.

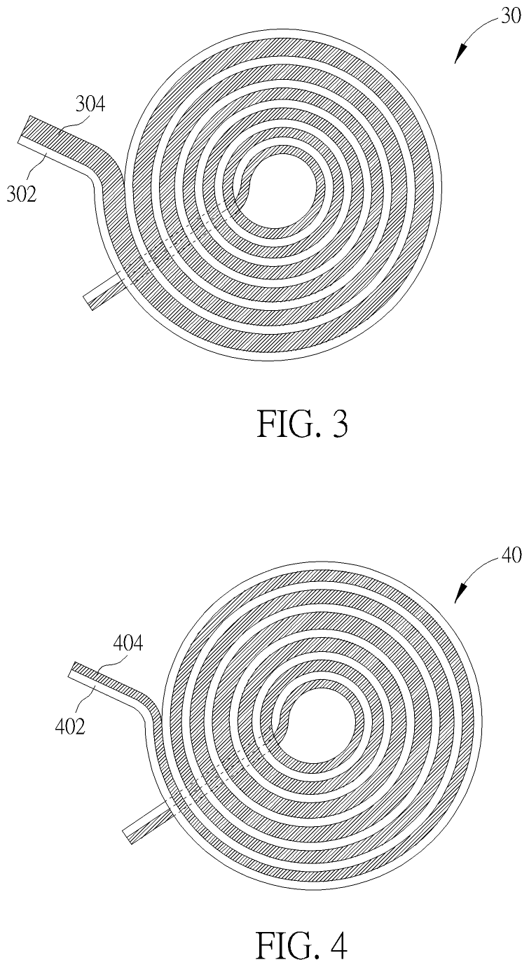

Note that the coil structure shown in FIG. 2 is one of various implementations of the present invention. In another embodiment, the torque may be changed in another manner. For example, the coil 30 of FIG. 3 is formed by winding a metal conducting wire 302 and a nonmetal spacing wire 304 together. During its manufacturing process, a larger torque may be applied first, and then the torque decreases gradually; hence, the inner rounds of the nonmetal spacing wire 304 has a smaller width, and the width increases from inside out.

FIG. 4 illustrates another coil structure, where the coil 40 is formed by winding a metal conducting wire 402 and a nonmetal spacing wire 404 together. In the manufacturing process of the coil 40, a larger torque may be applied first, and the torque decreases and then increases; hence, the nonmetal spacing wire 404 appears to have a smaller width on the inner rounds and outer rounds and a larger width on the middle rounds. As a result, the metal conducting wire 402 has a smaller gap at the inner side and outer side of the coil 40 and a larger gap in the middle of the coil 40.

In general, the energy distribution on the coil is that, the energy is maximum on the two terminals of the wire and minimum on the middle segment. If a nonmetal spacing wire with a fixed width is applied to perform winding, the metal wire densities on the two terminals and the middle segment of the coil may be identical. In contrast, by using a nonmetal spacing wire with a variable width, small impedance may be generated under the same coil area, and the coil may be designed to have a larger width of the nonmetal spacing wire on the middle segment, so that the metal wire density on the middle segment of the coil may be lower than the metal wire density on the two terminals of the coil, as the coil structure shown in FIG. 4. As a result, the wire length may be decreased on the middle segment where the energy is weaker, so as to reduce the impedance while increasing the power transmission efficiency.

Please note that the present invention aims at providing a coil structure that may satisfy various requirements of coil design, increase the coil efficiency, and facilitate mass production. Those skilled in the art may make modifications and alterations accordingly. For example, in the above embodiments, the coil is produced by winding a metal conducting wire along with a nonmetal spacing wire. In another embodiment, a plurality of nonmetal spacing wires may be applied to perform winding along with a metal conducting wire, in order to further reduce the metal wire density and impedance.

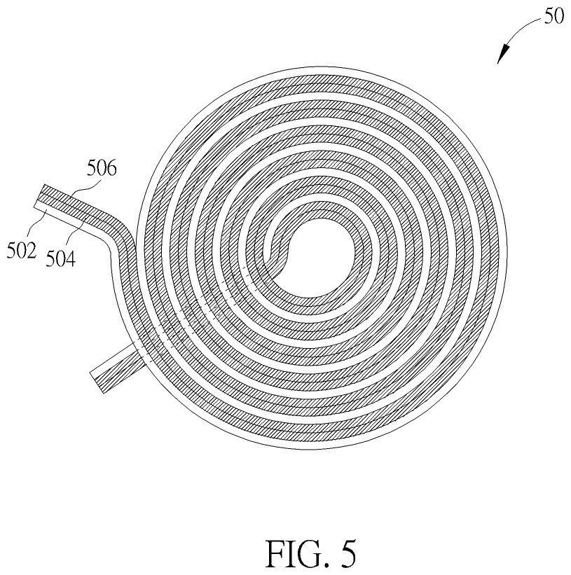

For example, FIG. 5 is a schematic diagram of a coil 50 according to an embodiment of the present invention. The coil 50 is formed by winding a metal conducting wire 502 and nonmetal spacing wires 504 and 506 together. The three wires are bonded on the same plane, and thus two adjacent rounds of the metal conducting wire 502 are separated by two nonmetal spacing wires 504 and 506. In another embodiment, a coil may be deployed to have more than three nonmetal spacing wires, and the number of spacing wires should not serve to limit the scope of the present invention.

In an inductive power supply system, the supplying-end coil and the receiving-end coil should perform sensing under a specific distance, so that a favorable power transmission efficiency can be achieved. In general, when the distance between the coils is farther, the power transmission efficiency will be worse. If the distance between the two coils is too far, the power transmission efficiency might not meet the requirements of the product specifications. If the distance between the two coils is too close, an over-sensing might occur. The over-sensing (also called over-coupling) means that the conducting wires in two coils may overlap completely and become very close when the distance between the two coils is very short. At this moment, the energies at the power supply end will be completely transmitted to the power receiving end, and the coil of the power receiving end will receive an extremely high voltage and send it to the back-end circuit. However, the voltage that the back-end circuit can withstand is limited, so the circuitry of the power receiving end is easily damaged under the condition of over-sensing.

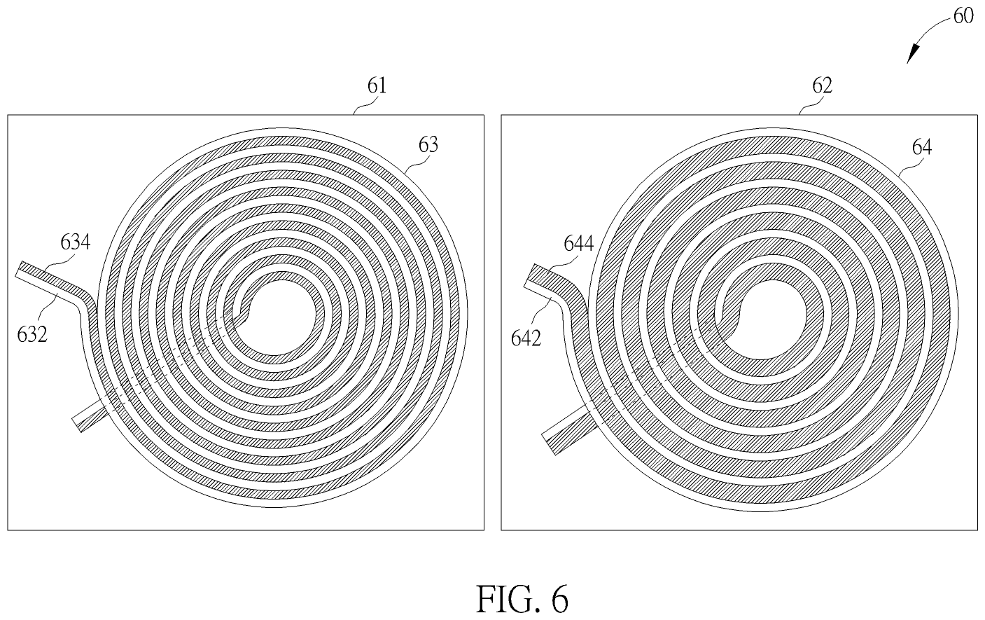

In the embodiments of the present invention, a metal conducting wire and a nonmetal spacing wire are wound in parallel to form a coil. The over-sensing may be avoided or mitigated by flexibly adjusting the nonmetal spacing wire. FIG. 6 is a schematic diagram of an inductive power supply system 60 according to an embodiment of the present invention. The inductive power supply system 60 includes a supplying-end module 61 and a receiving-end module 62. The supplying-end module 61 is provided with a supplying-end coil 63, which is formed by winding a metal conducting wire 632 and a nonmetal spacing wire 634 together. The receiving-end module 62 is provided with a receiving-end coil 64, which is formed by winding a metal conducting wire 642 and a nonmetal spacing wire 644 together. Similarly, the nonmetal spacing wires 634 and 644 may be implemented by using plastic wires or other materials without electricity conducting and electromagnetic sensing capabilities.

During the operations of the inductive power supply system 60, in order to avoid over-sensing between the supplying-end coil 63 and the receiving-end coil 64, the metal conducting wires 632 and 642 should be prevented from a high degree of overlapping when the two coils are close to each other. In such a situation, the nonmetal spacing wire 634 and the nonmetal spacing wire 644 may be designed to have different widths. As a result, even if the supplying-end coil 63 and the receiving-end coil 64 are very close, the positions of the metal conducting wires 632 and 642 are still staggered and do not highly overlap.

In this embodiment, the width of the nonmetal spacing wire 634 is smaller and the width of the nonmetal spacing wire 644 is larger; hence, as for the supplying-end coil 63 and the receiving-end coil 64 formed by winding, even if these two coils are close to each other, the position of the metal conducting wire 632 is still staggered to the position of the metal conducting wire 642, thereby avoiding the occurrence of over-sensing. Similarly, the nonmetal spacing wires having different widths may also be realized by using elastic plastic wires with torque adjustment in the coil winding process.

In other embodiments, the positions of the metal conducting wires may be staggered by other methods. For example, the supplying-end coil may apply a wider nonmetal spacing wire and the receiving-end coil may apply a narrower nonmetal spacing wire, and the purpose of staggering the metal conducting wires may also be achieved. In another embodiment, the supplying-end coil may be designed to have the structure as shown in FIG. 2, where the nonmetal spacing wire is wider on the inner rounds of the coil and narrower on the outer rounds of the coil. Meanwhile, the receiving-end coil may be designed to have the structure as shown in FIG. 3, where the nonmetal spacing wire is narrower on the inner rounds of the coil and wider on the outer rounds of the coil. As a result, the positions of the metal conducting wires may also be staggered, to prevent the circuitry of the power receiving end from being damaged due to over-sensing of the coils.

To sum up, the present invention provides a coil structure, which may be formed by winding a nonmetal spacing wire (such as a plastic wire) and a metal conducting wire together. In an embodiment, an elastic plastic wire may be applied as the nonmetal spacing wire, to flexibly adjust the gaps between different rounds of the metal conducting wire. Also, the supplying-end coil and the receiving-end coil are designed appropriately to stagger the positions of the metal conducting wires, so as to prevent the back-end circuit from being damaged due to over-sensing of the coils. The coil structure of the present invention may realize a larger sensing area by using a shorter wire, and thus is able to provide a favorable electromagnetic sensing capability and also keep lower coil impedance. In addition, the coils maybe produced by using the double-wire parallel winding technology in an automatic winding machine, which is capable of automatic mass production and has the advantage of low costs.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A coil for an inductive power supply system comprising:
a metal conducting wire; and
a nonmetal spacing wire;
wherein the metal conducting wire and the nonmetal spacing wire are wound together to form the coil.

2. The coil of claim 1, wherein the nonmetal spacing wire is a plastic wire.

3. The coil of claim 1, wherein the metal conducting wire and the nonmetal spacing wire are wound on a plane and bonded along a direction of the plane.

4. The coil of claim 1, wherein a first segment and a second segment of the metal conducting wire are separated by the nonmetal spacing wire to have a gap.

5. The coil of claim 1, wherein a first segment and a second segment of the nonmetal spacing wire have different widths.

6. The coil of claim 1, wherein an outermost round of the coil is the metal conducting wire.

7. The coil of claim 1, wherein the coil further comprises:
a plurality of nonmetal spacing wires for being wound with the metal conducting wire to form the coil.

8. An inductive power supply system comprising:
a first coil for a power supply end of the inductive power supply system, the first coil being formed by winding a first metal conducting wire and a first nonmetal spacing wire together; and
a second coil for a power receiving end of the inductive power supply system, the second coil being formed by winding a second metal conducting wire and a second nonmetal spacing wire together.

9. The inductive power supply system of claim 8, wherein the first nonmetal spacing wire and the second nonmetal spacing wire are plastic wires.

10. The inductive power supply system of claim 8, wherein the first nonmetal spacing wire and the second nonmetal spacing wire have different widths.
